(19) United States
(12) Patent Application Publication
(10) Pub. No.: US 2002/0002544 A1
(43) Pub. Date: Jan. 3, 2002

(54) Method and apparatus for user-sealing of secured postage printing equipment

(76) Inventors: J. P. Leon, San Carlos, CA (US); Chandrakant J. Shah, Stockton, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/792,881

(22) Filed: Feb. 23, 2001

Related U.S. Application Data
(63) Continuation-in-part of application No. 09/658,419, filed on Sep. 8, 2000.
(60) Provisional application No. 60/153,804, filed on Sep. 14, 1999.

(30) Foreign Application Priority Data
Sep. 13, 2000 (US) PCT/US00/25110

(51) Int. Cl. H04K 1/00; H04L 9/00; G06F 17/00; G07B 17/02; G06F 17/60

(52) U.S. Cl. 705/61; 705/408

(57) ABSTRACT

User-sealed postage printing apparatus and method comprises a printing device, operable to print a postage indicium and a processor. A weighscale is connected to the processor by an analog to digital converter, for example. A cavity for receiving a secure metering device (SMD) is provided. The cavity has an electrical connector for establishing a connection between the processor and the SMD. The SMD, once inserted, cannot be removed without being rendered unusable for postage printing and/or leaving visible evidence of tampering.

### CROSS-REFERENCE TO RELATED APPLICATIONS

This application claims priority from the following Patent Applications, the entire disclosures of which, including all appendices, are incorporated herein by reference for all purposes:

Application No. 09/658,419, filed Sep. 8, 2000, of J. P. Leon and Chandrakant J. Shah, entitled “Method and Apparatus for User-Sealing of Secured Postage Printing Equipment;” and

Application No. 60/153,804, filed Sep. 14, 1999, entitled “Method and Apparatus for User-Sealing of Secured Postage Printing Equipment.”

The disclosures of the following U.S. patent applications, are herein incorporated by reference in their entirety for all purposes:

Application No. 09/358,801, filed Jul. 21, 1999, entitled “Method and Apparatus for Postage Label Authentication;”

Application No. 09/708,971, filed Nov. 7, 2000, entitled “Providing Stamps On Secure Paper Using A Communications Network;” and

Application No. 60/216,779, filed Jul. 7, 2000, entitled “System And Method Of Printing Labels.”

### BACKGROUND OF THE INVENTION

The present invention relates generally to the field of secure printing, and specifically to methods and apparatus that enable an end user to secure a general purpose label printing device to perform postage printing.

A postage meter allows a user to print postage or other indicia of value on envelopes or other media. The postage meter can be leased, rented, or purchased where allowed, from a commercial group (e.g., Neopost Online). Typically, the user purchases a fixed amount of postage value beforehand and the meter is programmed with this amount. Subsequently, the user is allowed to print postage up to the programmed amount. The meter typically includes a print mechanism and mechanical arrangements and/or electronic control circuitry that direct the operation of the print mechanism.

Because the meter is capable of printing postage having a value, security is critical to prevent unauthorized use. Postage meters are required by postal regulations to incorporate a variety of security features, and to be handled in accordance with certain prescribed methods to maintain security of postal funds. One such traditional method involves checking a new meter into service and having it sealed by the postal authorities. Originally this required a trip to a post office, to identify the user to the postal authorities, and to have the meter sealed with a physical security seal, such as a lead-and-wire crimped seal or the like. Examples of secured postage meters are disclosed in U.S. Pat. No. 4,742,469, entitled “Electronic Meter Circuitry,” issued May 23, 1988, and U.S. Pat. No. 4,484,307 entitled “Electronic Postage Meter Having Improved Security And Fault Tolerance Features,” issued Nov. 20, 1984, both incorporated herein by reference.

Presently, developments in the postage meter field have streamlined this procedure to some extent, but conventional techniques still require the user to apply for and obtain a license, after which the sealed meter must be physically delivered to the user by the licensed meter manufacturer. The license for the unit is then registered with the postal authorities on-line. Although this process is less cumbersome than taking each unit to a post office for sealing, it is still significantly unwieldy.

What is needed is a meter design and/or distribution method that will allow the meter installation to be performed by the user, will protect the fiscal interests of the parties involved (i.e. the postal service, the user and the meter manufacturer/distributor) and will meet postal regulations.

### SUMMARY OF THE INVENTION

The present invention provides techniques for enabling users to perform secure installation and sealing of their own postage printers without requiring direct oversight by any other party. Embodiments according to the present invention provide advantages of a general purpose label printer that is available off the shelf, but has a plurality of configurable modes that enable printing of postage.

In one representative configuration, a label printer includes a processor and a print engine. The label printer preferably has a mechanism to interface to a host computer and/or a remote service center. A postage metering device is encapsulated into a plug-in module, which can be inserted into the label printer to control postage printing at the user's site. The plug-in module, known as a “Secure Metering Device,” or “SMD,” can be provided to users by a licensed meter manufacturer. The SMD can be embodied as a smartcard, for example, or other types of secured devices. The SMD provides a secure storage for the postage metering registers and preferably provides cryptographic functions that implement security features along the lines of the Information-Based Indicia Program (IBIP) promulgated by the United States Postal Service.

Once inserted, a subsequent attempt at removing the SMI disables the device from being used to print postage. Alternatively, or in addition, once the SMD device is inserted into the label printer, a one way latching mechanism ensures that the SMD cannot be removed or tampered with without either destroying the device, or leaving visible evidence of tampering.

In another representative configuration, a modem or other interface provides a connection between the SME and a remote recharging facility. The label printer prints postage drawing upon postal credit stored within the SMD. At a convenient point, the user can purchase more postal credit via download from the remote postage recharging facility. An optional weighscale may be integrated with the other components in a single enclosure, or may be separately housed.

The label printer with installed SMD can print postage without being connected to a postage metering device over a network. The SMD is regulated by the postal authorities in a manner similar to a conventional meter. However, according to the present invention, regulated activities, such as sealing the meter and checking it into service, can be performed at the user's site by the user, with full security, and without the necessity for direct oversight by the postal authorities or the meter manufacturer. Further, the label printer with installed SMD can be used as a standalone postage meter, although postage printing can also be initiated by user actions at the host computer.

In another representative embodiment, a user-configurable user-sealed label printing apparatus capable of being configured to print postage comprises a print engine, operable to print a postage indicium, a processor, and optionally, a weighscale connected to the processor by an analog to digital converter, or other interface. An optional interface is provided to enable the apparatus to be connected to a local host computer and/or a network, for example. The apparatus has a cavity for receiving an SMD. The cavity has an electrical connector for establishing a connection between the apparatus and the SMD. Once inserted, a subsequent attempt at removing the postage metering device disables the SMD from being used to print postage. In some specific embodiments, a single enclosure houses the print engine, the processor, the weighscale, the interface, and the cavity. In other specific embodiments, a single enclosure houses the printing device, the processor, the interface, and the cavity, with the weighscale attached separately.

In some specific embodiments, a “one-way” latch keeps the SMD in place, once installed. In other embodiments, a cover secures the SMD in place, and a “one-way” latch keeps the cover secured and inhibits tampering with the SMD once it has been installed. Opening the cover causes visible evidence of tampering. In another specific embodiment, installing the SMD trips a sensor, such that a later attempt to remove the SMD will cause it to be deactivated, by one or more of: zeroing the postage stored within the meter, clearing cryptographic keys stored within the SMD, or other types of disabling. The sensor can be a micro-switch, proximity sensor, optical sensor, mercury switch, relay, or the like. Software executed by the processor detects and authenticates the presence of the SMD, and through a series of message transactions enables the SMD for use in the apparatus, and disables the SMD for use if it is removed from the apparatus. Still further embodiments can use combinations of these techniques to secure the SMD.

In a specific embodiment, the user places the SMD into service by inserting it into a cavity within the label printer. The cavity can be secured with a cover. Before insertion of the SMD, the securable cover may be opened and closed freely. Correct insertion and electrical connection of the SMD activates the securing feature by arming a one-time latch, which in specific embodiments can be any of several electrical, electronic, mechanical, or electromechanical latches. When the SMD is inserted in the correct position, and the interface connector is correctly mated, closing the cover activates the latch mechanism, effectively sealing the SMD. Inserting the SMD into the cavity automatically couples a data-line connector, and in specific embodiments, a phantom power connection, to establish an I/O interface between the SMD and the main processor of the label printer. The latch prevents removal of the SMD without leaving distinct physical evidence. For example, in a specific embodiment, the attempted removal can permanently disable the SMD. Other specific embodiments may also include activating local and/or remote alarms, or a combination of any of these features.

The cover can be physically held closed by the latch, so that attempts to reopen the cover in order to gain access to the SMD or its connections result in obvious damage, which provides physical evidence of tampering. Alternatively, re-opening the cover after the latch is secured produces an electronic signal that activates security features of the SMD. The security features may be hardwired security circuits, software security routines, or any combination of hardware and software. When activated, these security features can permanently disable the SMD's operation. Security features can also activate audible and/or visible alarms at the meter site. Also, an alarm signal can be sent to the user's host computer, the post office central-office computer, and/or the meter manufacturer's central-office computer. In such specific embodiments, installation of a new SMD can optionally restore the functionality of the postage printer system.

If an electronically activated latch is used, it is also possible to re-credit the system by distributing single-use SMDs, pre-loaded with postal credit, which can be removed and replaced by the user after the credit is exhausted. The used SMD is deactivated by the electronic latching device when the cover is opened to remove it from the printer. Since the device is permanently disabled, it does not constitute a security risk, and can safely be discarded or recycled without special precautions to prevent unauthorized re-use. The processor securely resets the latch upon insertion of the new SMD, thus allowing a new operating cycle to begin. This process can be repeated as many times as desired.

A further understanding of the nature and advantages of the invention herein may be realized by reference to the remaining portions of the specification and the attached drawings.

### BRIEF DESCRIPTION OF THE DRAWINGS

FIGS. 1A-1C illustrates a representative postage printer security enclosure in a specific embodiment;

FIGS. 1D-1E illustrate alternative postage printer security enclosures in some specific embodiments;

FIGS. 2A-2B illustrate schematically representative label printers that are configurable to print postage in some specific embodiments;

FIGS. 3A-3C illustrate a representative technique for securing an SMD within a label printer using a mechanical fastening mechanism in a specific embodiment;

FIG. 4 illustrates a detail diagram of one technique for securing an SMD within a label printer using an electronic sensor in a specific embodiment;

FIGS. 5A-5C illustrate flowcharts of representative methods for sealing and registering a postage printer using an SMD having an on-line postage credit purchase capability in specific embodiments; and

FIG. 6 illustrates an example of an individual postage stamp printed by a label printer in a specific embodiment.

### DESCRIPTION OF THE SPECIFIC EMBODIMENTS

Introduction

The present invention provides devices and methods for user configuration, set up, and securing of a label printing device for printing postage. A label printing device according to the present invention can operate in one of a plurality of configurations. In one configuration, the label printer operates as a stand-alone general purpose label printing unit that, upon insertion of a secure metering device (SMD), becomes capable of printing postage. A variety of techniques can be used to secure the SMD to prevent tampering and the like. In one configuration, the label printer can connect to a remote postage recharging facility to download additional postage credit into the SMD.

The label printer can function in a stand alone mode, but also can couple to a modem, or other communications interface, in order to communicate with one or more of the following entities: (1) a service center, (2) a central dispatch facility, (3) postal authorities, (4) the manufacturer, and the like. These entities are collectively referred to as a “service center.” Thus, the term “service center” refers to any entity that may have a need or desire to know about, or an ability to act on, a status or problem with a label printer configured to print postage (e.g., for purpose of recharging or auditing the SMD's accounting registers).

In specific embodiments, the system possesses attributes specified by the United States Postal Service's Information Based Indicia Program (IBIP). Thus the SMD preferably belongs to a class of computer peripherals that performs some or all the security functions of an IBIP postal security device (PSD). The PSD is a device or module that implements security functions for indicia customers. The PSD core security functions include secure management of a descending register (DR) that tracks the remaining amount of money available for indicium data creation, an ascending register (AR) that tracks the total postage value used by this PSD, and cryptographic digital signature generation. For further description of PSD functions, reference may be had to a publication entitled, “Information-Based Indicia Program (IBIP), Performance Criteria For Information-Based Indicia And Security Architecture For Open EBI Postage Evidencing Systems (PCIBI-O),” by the United States Postal Service (USPS), Draft of Feb. 23, 2000, which is incorporated by reference. The document has parts A, B, C, and D specifying respectively the Indicium, the Postal Security Device (PSD), the Host System, and the IBIP Key Infrastructure.

As used herein, the term “indicium” indicates an imprinted designation used on a mailpiece denoting evidence of postage payment. The indicium in an IBIP-type system includes a machine readable two dimensional (2D) symbol and certain human readable information. The 2D symbol includes the digital signature and may be, for example, a stacked barcode such as PDF417 or a matrix format such as Data Matrix. The human readable information may include, for example, the device ID, the amount of the applied postage, the date of mailing, the city, state, and ZIP code of the licensing post office.

A user can obtain a plug-in module, comprising an SMD, from a licensed meter manufacturer. The SMD can be implemented as a smartcard, for example, or in other types of secured devices. An SMD provides a store for the purchased postage for the printer, thus providing an alternative to Internet type postage dispensers and the like. For example, with the SMD installed, the label printer-host combination can print postage without a modem connection. Further, in specific embodiments, the label printer need not be attached to a host computer to be used as a standalone postage printer. The SMD comprises components regulated by the postal authorities in a manner similar to a conventional meter. In accordance with the present invention, the regulated steps of sealing the meter and checking it into service can be performed at a user's site by the user with full security, obviating the necessity for direct oversight by the postal authorities or the meter manufacturer.

In one mode of operation, a label printing device having an SMD installed can receive and store postal credit purchased from a source over a network. The postal credit can be safely stored within the SMD. The user can print postage drawing upon the stored postal credit from the SMD, without the necessity of maintaining a connection to a service center.

In an alternative mode of operation, a user can purchase the SMD pre-loaded with postal credit. The SMD is inserted into the label printing device, with postal credit already stored within the SMD. The user may then proceed to print postage drawing upon the stored postal credit from the SMD, without the necessity of maintaining a connection to a service center. When the supply of postal credit becomes low, or is exhausted, the user can remove the SMD, effectively disabling it, so that it can be discarded or recycled. Alternatively, the user could return the SMD to the service center to purchase more postal credit. Still further, in some embodiments, the user could establish a connection with a service center and purchase additional postage credit, which may be stored in the SMD.

In another configuration, the label printer can be connected to a postage metering device over an internet, or other type of connection. In this configuration, the label printer can download postage indicia information and print postage indicia. A particular example of a recently announced system, currently under development, that does not require a separate postal license, is to be marketed by Neopost Online under the name SnapStamp™. In this system, a user logs on to a website and purchases postal indicia for downloading and printing on secure paper. In addition to IBIP-type features and physical security features in the labels, the system makes use of serialized label sheets or strips.

System Hardware

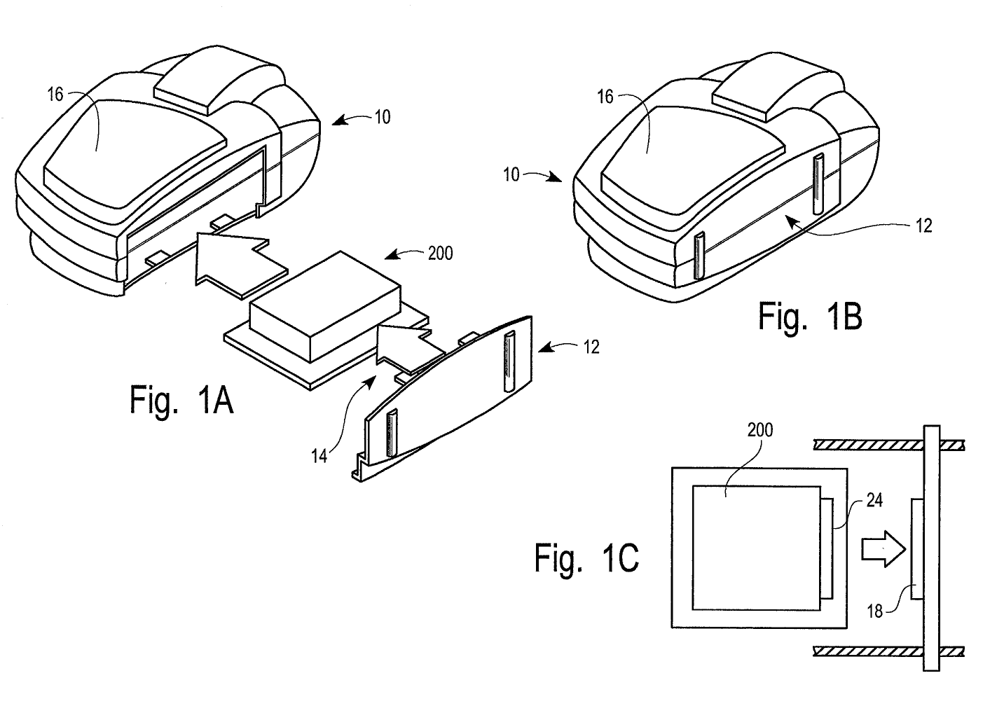

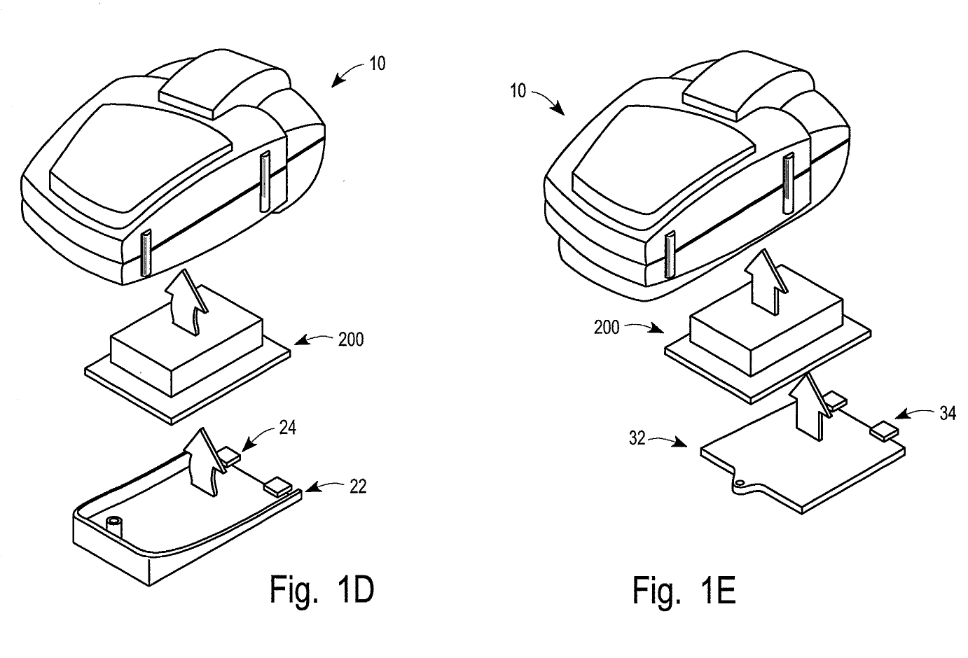

FIG. 1A illustrates a representative printer security enclosure in specific embodiments according to the present invention. In the embodiment illustrated by FIG. 1A, a label printer 10 has a cavity in the side for receiving an SMD 200. A cover 12 covers the cavity after the SMN has been installed. One or more latching fasteners 14 secure cover 12 to the printer enclosure. A weighscale 16 can be integrated into the printer unit, or alternatively, attached separately. FIG. 1B illustrates a representative printer security enclosure, such as label printer 10 of FIG. 1A, with the cover 12 locked into place. FIG. 1C illustrates a detail view of insertion of SMD 200 into the cavity of label printer 10 in the representative embodiment. In alternative embodiments, latching fasteners can latch the SMD 200 into place. As SMD 200 is inserted, an electrical connector 18 within the cavity of the label printer 10 mates with a corresponding electrical connector 24 of the SMD 200. Electrical connection can be made automatically during insertion of the SMD into the cavity of the label printer 10. Alternatively, the user can mate the electrical connectors of the SMD and the label printer manually.

FIG. 1D illustrates an alternative printer security enclosure in a specific embodiment according to the present invention. In this embodiment, the label printer 10 has a cavity in the bottom for receiving an SMD 200. A bottom cover 22 covers the cavity after the SMD 200 has been installed. One or more latching fasteners 24 secure cover 22 to the printer enclosure. FIG. 1E illustrates another alternative printer security enclosure in which the cavity is again located in the bottom of the printer 10. A hatch type cover 32 secures the SMD into place. One or more latching fasteners 34 secure cover 32 to the enclosure of printer 10.

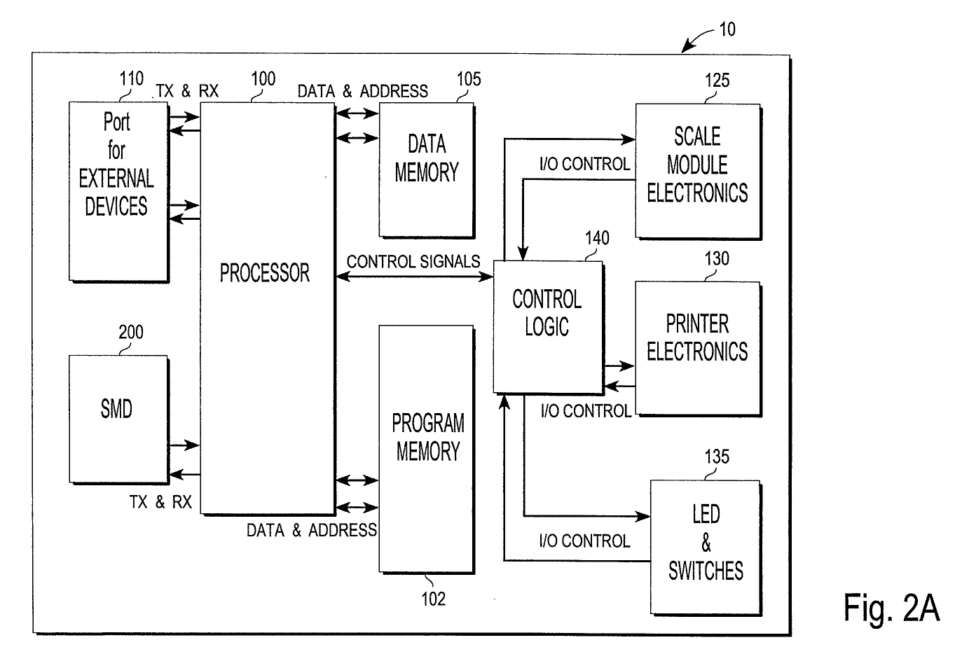

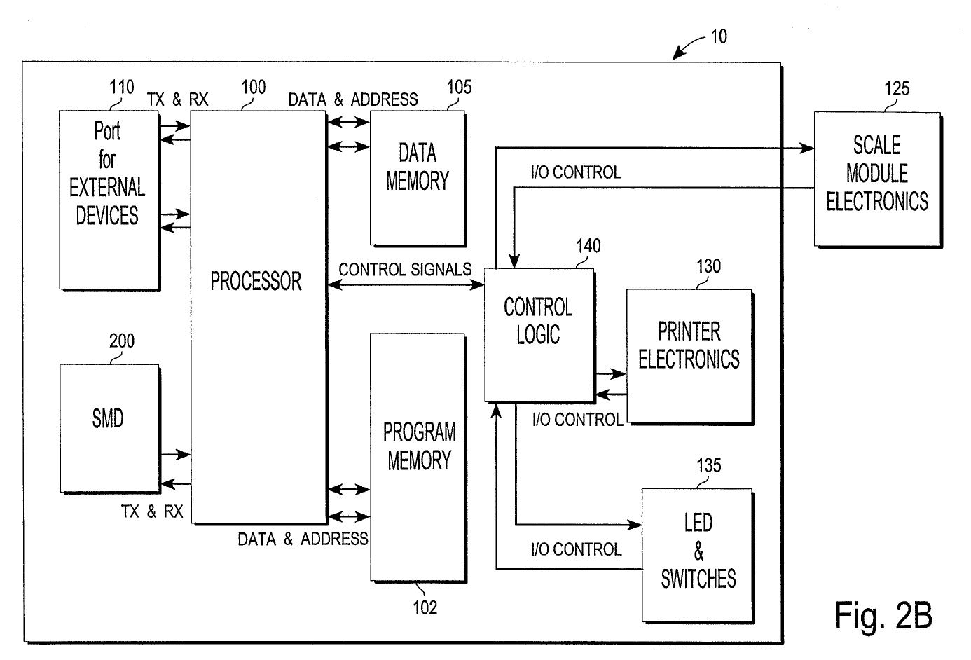

FIG. 2A is a system block diagram of label printer 10, configured with SMD 200 so as to function as a postage printer and a self-contained postage meter. Overall operation of the label printer is controlled by a processor 100 with associated program memory 102 and data memory 105. Processor 100 can be a general purpose microprocessor, a microcontroller, or any type of similar device. SMD 200, when inserted into the cavity of the label printer, communicates with processor 100, and all communications with the SMD are conducted via processor 100. Label printer 10 is shown as having a port 110 to allow processor 100 to communicate with external devices such as the host processor (not shown). Thus, the label printer can be operated under host control based on commands received at port 110. This port can support communications with the service center via the host's modem or other network connection (not shown) for purposes of downloading postage into SMD's postal registers and communicating messages between the SMD and the service center for other transactions.

Processor 100 also communicates with scale module electronics 125, printer electronics 130, and indicators (LEDs) and switches (shown as a block 135). While the user normally communicates with the label printer via the host user interface (input devices, display, and host software), the switches and LEDs provide a rudimentary user interface that is independent of the host user interface. For example, one of the switches can be used to allow the user to print a single stamp of a predetermined denomination when the label printer is not connected to the host computer (or when the host computer is not on).

The communication with the scale, printer, and indicators/switches is shown as occurring via control logic 140. Depending on the particular implementation, control logic 140 can be designed to perform many of the functions for the scale and printer, or can be very simple, with most of the functions performed by the printer and scale electronics or by processor 100. For example, the operations for converting a digitally signed indicium message (generated by SME 200) to an indicium bitmap containing the 2D machine-readable elements can be allocated or shared among the circuit elements in many different ways. For example, the conversion of binary data into the 2D symbology could be performed by processor 200, or could be performed by an ASIC in control logic 140.

FIG. 2B is a system block diagram of label printer 10, configured with SME 200 so as to function as a postage printer and a self-contained postage meter in another embodiment. In FIG. 2B, the scale module electronics 125 are housed in a separate enclosure from the remainder of the label printer unit components. The scale module electronics can be incorporated into a separately connected scale unit. In the embodiment illustrated by FIG. 2B, a solid line encloses the components comprising the printer unit 10, all of which are packaged in a single enclosure. The function of the elements shown in FIG. 2B is substantially the same as those shown in FIG. 2A, so the description of these elements with respect to FIG. 2A applies to the function of these elements with respect to the embodiment illustrated by FIG. 2B.

The SMD 200 provides secure storage for postal credit in a modular package within a secure enclosure. The SMD may be implemented on a smartcard, flash memory, and the like. In a specific embodiment, the SMD is packaged within a tamperproof enclosure, typically equipped with security features such as those described FIPS-140-1, or, alternatively, those described in U.S. patent application No. 09/358,802, or others.

The SME 200 is inserted into a cavity within the printer unit, configuring the printer unit from a general purpose label printer into a postage printer. The SMD contains postal revenue registers which can only be rewritten under controlled conditions. An IBIP-compliant PSD generates a cryptographically signed indicium message, which is formatted for indicium printing outside the PSD. However, subject to approval by the relevant postal authorities, the SMD could also contain software to configure the postal indicium imprint, which may include secured imprints, 2D barcodes, and other security features as well. In some specific embodiments, the SMD provides secure communication with other postage metering system elements by means of cryptographic techniques. For example, in a specific embodiment, cryptographic techniques can be used to provide secure communication between the label printer unit and a host computer. Alternatively, other specific embodiments do not include cryptographic functions in the SMD. The SMD can be packaged as a separate unit, or can be installed within the secured or unsecured enclosure of another device. Since the SMD provides revenue security functions, the ancillary functions of a traditional postage meter, such as printing, I/O, and power supply, can be provided by commercially available hardware.

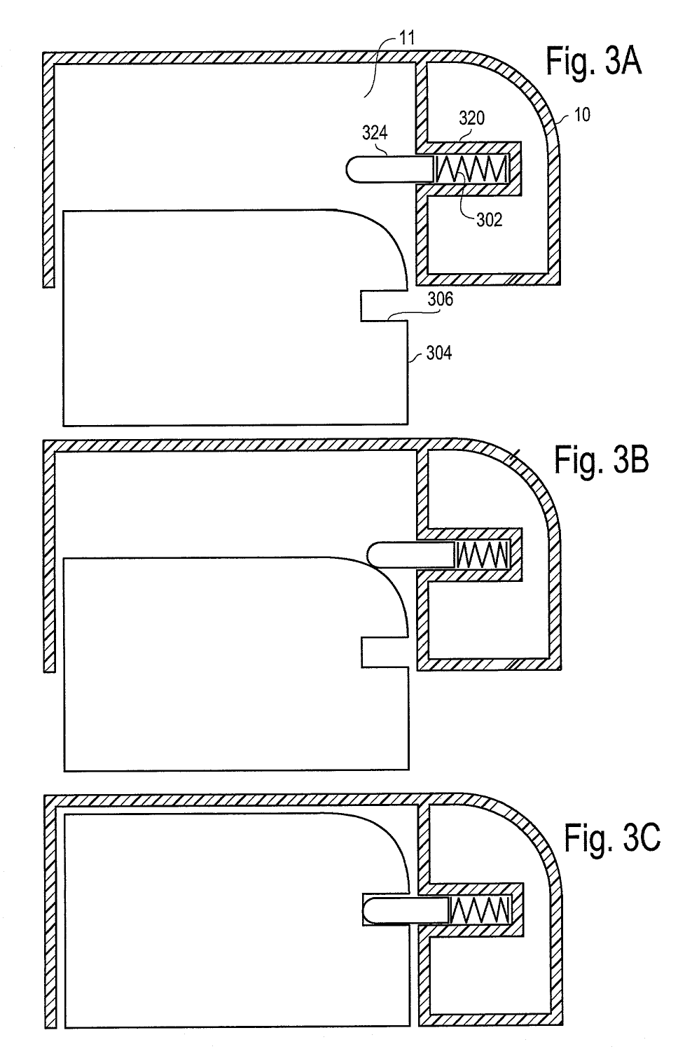

FIGS. 3A-3C illustrate a representative technique for mechanically securing an SMD within a label printer in a specific embodiment. In FIG. 3A, a representative one way latch mechanism 320 includes a receptacle 11, that receives a latching fastener 304 inserted in an axial direction into receptacle 11. One or more locking members 324 secure latching fastener 304 into place when fully inserted into receptacle 11. A locking member 324 is disposed for movement in a transverse direction to the insertion direction of latching fastener, and is biased by a spring 302, to mate with a recess 306 in latching fastener 304. However, other arrangements designed to maintain contact between locking member 324 and recess 306 readily apparent to those skilled in the art can be used in various specific embodiments.

FIGS. 3B-3C illustrate the insertion and latching. FIG. 3B illustrates latching fastener 304 being partially inserted into the receptacle 11. As latching fastener 304 is inserted into receptacle 11, locking member 324 is moved in a transverse direction against spring 302 by a contact surface of latching fastener 304. FIG. 3C illustrates latching fastener 304 fully inserted into receptacle 11 and locked into place by locking member 324. Spring 302 exerts force onto locking member 324 to maintain its presence within recess 306 of latching fastener 304, locking latching fastener 304 into place within receptacle 11. The one way latching mechanism illustrated in FIGS. 3A-3C can be used to secure cover 12 to label printer 10, or the SMD 200 in the body of label printer 10, in various embodiments.

In embodiments illustrated by FIGS. 1A-1C, latching fasteners 304 attach a side cover 12 to label printer 10 in order to secure the SMD in place. FIGS. 1D-1E illustrate embodiments in which latching fasteners 304 attach a bottom cover 22, or a bottom cover 32 to label printer 10 in order to secure the SMD in place. In a specific embodiment, the cover is fabricated to fail when a force smaller than the amount of force required to overcome the one way latch is applied to it, so that, once fastened, removal of the cover results in visible evidence of tampering. In alternative embodiments, the recess 306 can be incorporated into the SMD packaging itself, so that locking member 324 secures the SMD in place directly. Locking member 324 mates with the recess 306 that is part of the SMD package, which is inserted into receptacle 11. Once inserted, removal of the SMD causes damage to the SMD itself, rendering it inoperable. Still other embodiments can comprise both methods to secure the SMD against tampering.

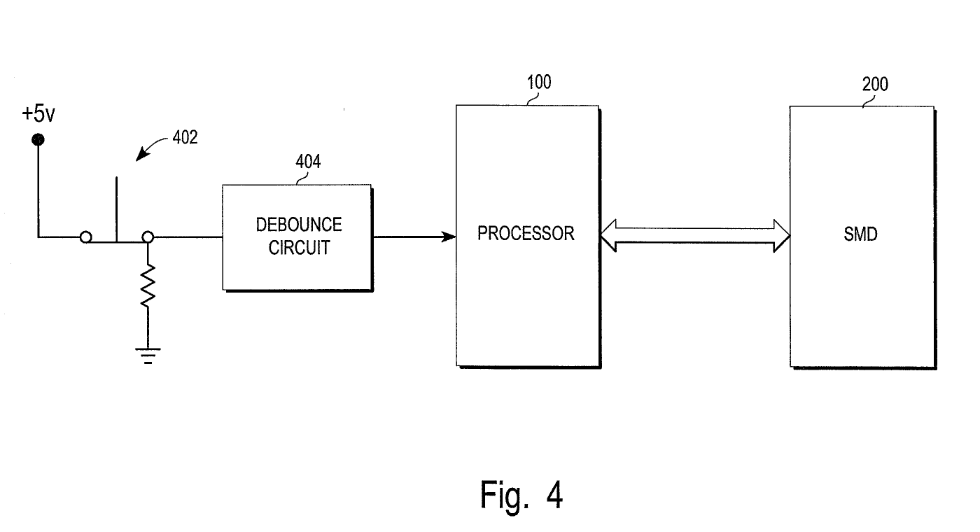

FIG. 4 illustrates a detail diagram of one technique for securing an SMD within a label printer 10 using an electronic sensor in a specific embodiment. FIG. 4 illustrates an electronic sensor 402 coupled to a switch debounce circuit 404. Electronic sensor 402 can be a contact switch, a proximity sensor, an optical sensor, a mercury switch, a relay, or the like. Electronic sensor 402 detects the closing of the cover 12, for example, after the SMD 200 has been installed. Debounce circuit 404 insures that only one signal is passed to processor 100 for a particular instance of opening or closing the cover 12. Debounce circuit 404 can be embodied in a one shot flip flop, or the like, as is commonly known in the art. Processor 100, upon detecting that the cover has been opened, an SMD 200 has been installed, and that the cover 12 has been closed, determines that the SMD 200 has been installed and sealed.

The SMD 200, upon detecting a power up provided to it, begins to query processor 100 to determine if it is secure. Processor 100 responds with an indication that it has been secured. Subsequently, SMD 200 can continue to poll processor 100 to insure that a secure state exists. So long as processor 100 has not detected an attempt to open cover 12 from sensor 402, via debounce circuit 404, the processor will respond acknowledging that the secure state exists. If the processor detects an attempt to open the cover, it will cease to respond to polling by the SMD. The SMD, upon not receiving a secure acknowledgement to a poll, can initiate processing to secure itself. For example, the SMD can clear cryptographic keys stored within itself. Further, in some embodiments, the SMD can clear one or more postage credits stored within registers located within it. The task of determining whether the printer and SMD are in a secure state can be shared among the control logic 140, debounce circuit 404 and processor 100 in a variety of different ways. Depending upon the particular implementation, control logic 140 can be designed to perform the switch debouncing function, and can forward the signal received from sensor 402 to the processor 100. Alternatively, the control logic 140 can determine whether the printer and SMD are in a secure state and forward this information to the processor 100. Another alternative, as illustrated by FIG. 4, is to provide the signal from the sensor 402 to the processor 100 via the debounce circuit 404 directly. The processor 100 can be interrupted by a change in the signal, or can poll the state of the cover, depending upon the particular implementation.

The SMD has an independent power source to assure that it can perform self-disabling functions in the event that it is tampered with. Attempts to remove the SMD by defeating the sensor 402, such as by removing power, and so forth, will still result in the SMD losing the secure state acknowledgement to its poll, and thus disable itself. The SMD performs power up and power down sequences responsive to power up and power down of the printer unit. In power down state, the SMD detects attempted removal by sensing a lost ground, for example, or the like.

In a specific embodiment, processor 100 and/or SMD 200 can activate security features, such as an audible and/or visible alarm, for example, responsive to detecting an attempt to tamper with the SMD. Security features can also generate an alarm signal to a user's host computer, and/or a post office central-office computer, and/or a meter manufacturer's central-office computer.

In a specific embodiment, inserting a new SMD enables the postage printing function of the printer to be restored. The disabled SMD can be physically delivered to a service center to be reactivated by an authorized person, or recycled.

While the above has illustrated the present invention using embodiments having a sensor and processor, the present invention is not so limited. Those skilled in the art can readily appreciate that the present invention can be embodied using circuitry instead of a processor, different types of sensing units, and the like, for example.

System Operation

After installation of the SMD into the label printer, the resulting postage printing system is registered with the postal authorities on-line. In a specific embodiment, on-line registration is performed by the user's computer, linked by modem to a central computer facility. The central facility is maintained either by the post office or the licensed manufacturer. The necessary administrative actions are then accomplished on-line. Administrative functions may include, but are not limited to, checking the meter into or out of service, periodic inspections, purchase of additional postal credit, downloading purchased postal credit into the SMD's registers, notification that the SMD's security features have been activated, or the like.

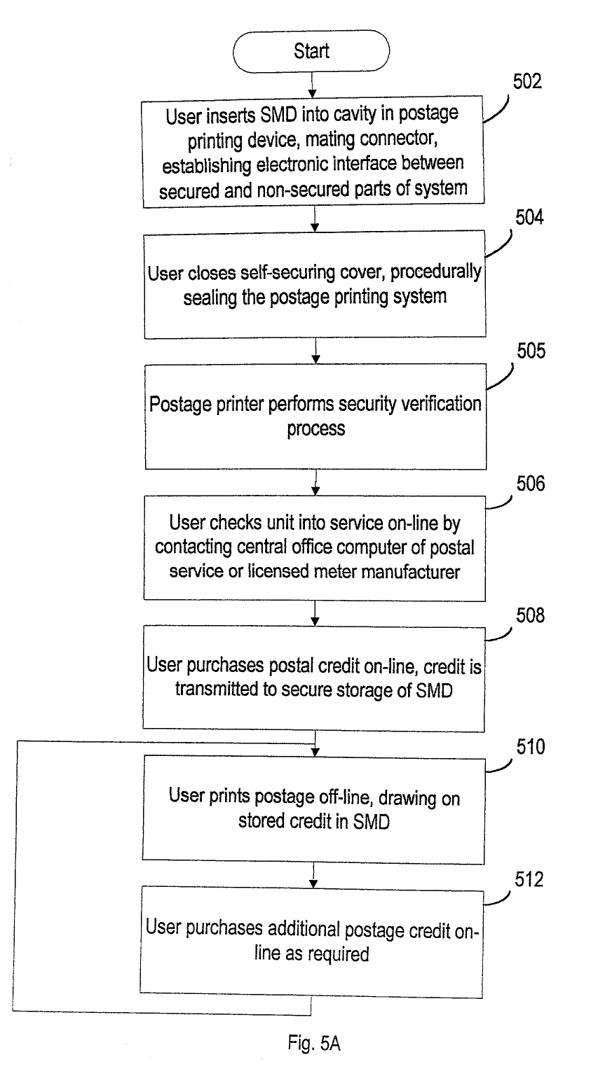

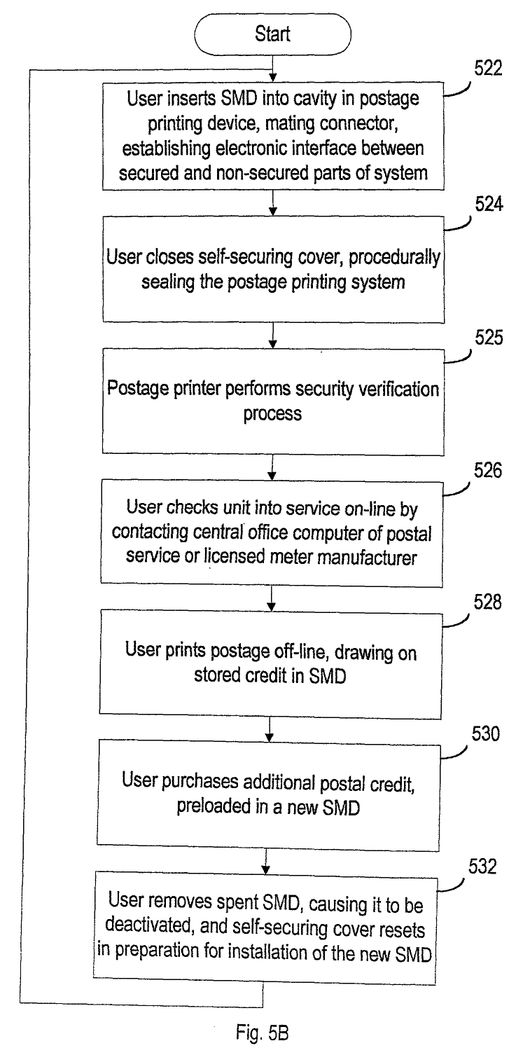

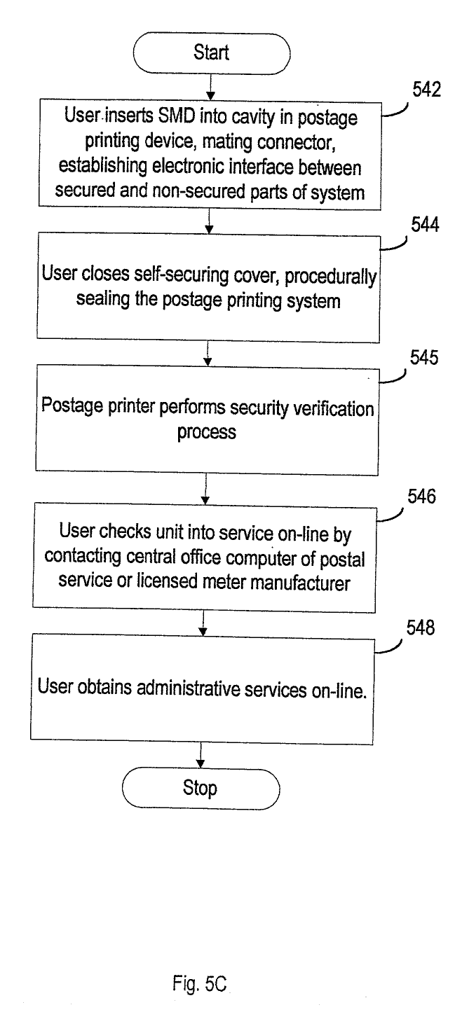

FIG. 5A illustrates a flowchart of a representative method for sealing and registering a label printer to print postage using an SMD having an on-line postage credit purchase capability in a specific embodiment. FIG. 5A illustrates a step 502, in which a user inserts the SMD device into a cavity in the printing device. The SME mates with a connector contained within the cavity in order to establish electronic interface between secured parts and non-secured parts of the system. Alternatively, in some embodiments the user can mate a connector manually. In a step 504, the user closes the self-securing cover, procedurally sealing the postage printing system. In a step 505, the printer unit performs a security verification. Then, in a step 506, the user checks the unit into service using an on-line connection to a service center (e.g., a central office computer of the postal service, or a licensed meter manufacturer). Next, in a step 508, the user purchases postal credit on-line. The postal credit is transmitted to, and stored within, the secured storage area of the SMD. In a step 510, the user prints postage off-line, drawing on the stored postal credit in the SMD. When postal credit becomes exhausted, or nearly so, in a step 512, the user purchases additional postage credit on-line, which is also stored within the SMD. Processing then continues with step 510.

FIG. 5B illustrates a flowchart of a representative method for sealing and registering a label printer to print postage using an SMD having pre-loaded postal credit in a specific embodiment. FIG. 5B illustrates a step 522, in which a user inserts the SMD device into a cavity in the printing device. The SMD is mated with a connector contained within the cavity in order to establish electronic interface between secured parts and non-secured parts of the system. In a step 524, the user closes the self-securing cover, procedurally sealing the postage printing system. In a step 525, the printer unit performs a security verification. Then, in a step 526, the user checks the printer unit into service using an on-line connection to a service center. In this specific embodiment, the SMD is purchased having postal credit pre-loaded in it. In a step 528, the user prints postage off-line, drawing on the stored postal credit in the SMD. When the postal credit becomes exhausted, or nearly so, in a step 530, the user can purchase additional postal credit preloaded in a new SMD. In a step 532, the user removes the SMD that has its postal credit exhausted, and replaces it with the new SMD purchased in step 530. Removing the exhausted SMD causes it to be deactivated, so that it can be safely recycled. Removal of the SMD causes the security mechanism of the cover to be reset in preparation for loading the new SMD in step 522.

FIG. 5C illustrates a flowchart of a representative method for sealing and registering a label printer to print postage using an SMD in a specific embodiment. FIG. 5C illustrates a step 542, in which a user inserts the SMD device into a cavity in the printing device. The SMD is mated with a connector contained within the cavity in order to establish electronic interface between secured parts and non-secured parts of the system. In a step 544, the user closes the self-securing cover, procedurally sealing the postage printing system. In a step 545, the printer unit performs a security verification. Then, in a step 546, the user checks the unit into service using an on-line connection to a service center. Next, in a step 548, the user obtains administrative services on-line. Such services can include, in specific embodiments, periodic meter inspections, transmittal of tamper alarms to authorities, checking the meter out of service and the like.

Representative Output

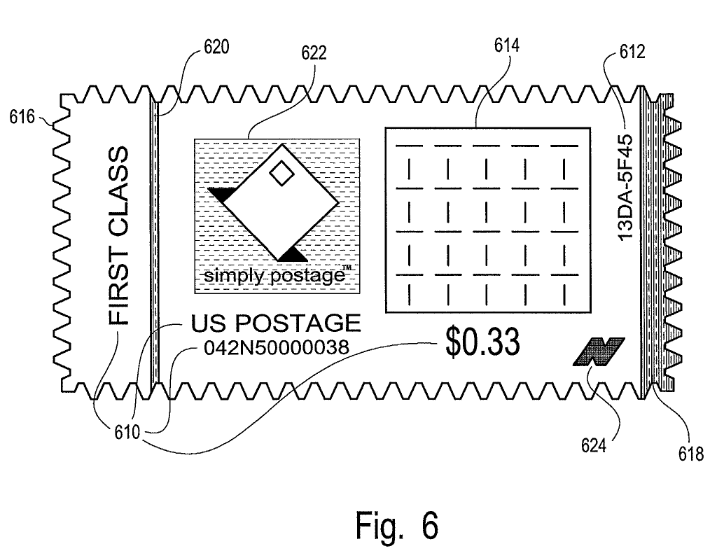

FIG. 6 illustrates an example of an individual postage indicium printed by a label printer configured to print postage in a specific embodiment. The individual postage stamp in FIG. 6 is an example of a label that has an indicium printed on it. The indicium includes human readable information 610, 612 and machine readable information 614. For example, human readable information 610 may include a postage amount, e.g., “$0.33;” the mail class, e.g., “FIRST CLASS;” a meter number, e.g., “042N50000038,” and other types of information. The human readable information may also optionally include a serial number 612, e.g., “13DA-5F45” as depicted in FIG. 6. Although illustrated in FIG. 6 as a pattern of hash marks, machine readable information 614 may include a two dimensional code, which includes the digital signature, and other information, for example. The two dimensional code may be, for example, a matrix symbology (e.g., data matrix), or a two dimensional bar code (e.g., PDF 417).

The postage stamp depicted in FIG. 6 has serrated edges 616. The serrated edges provide a security feature to the individual label on which the stamp is printed and also provide the “look and feel” of a conventional United States postage stamp. Other security features on the stamp may include a colored stripe 618 extending across a side of the stamp, a dual-parallel line of microprint 620, a logo 622, for example a “simply postage™” logo, a watermark 624, for example, “N,” and other features. Microprint 620 may comprise one or more lines of text, for example, each line may contain the word “Neopost,” for example, printed several times. The paper on which the postage stamp is printed may itself have several security features. Details about these security features and the use of secure paper and/or a serial number for printing postage are discussed in U.S. application No. 09/611,375, “Providing Stamps On Secure Paper Using A Communications Network,” filed Jul. 7, 2000, the disclosure of which is herein incorporated by reference in its entirety for all purposes.

Conclusion

In conclusion, it can be seen that specific embodiments can provide improved security relative to conventional techniques. The self-securing cover, the internal security features of the SMD, the alarm-generating features of the SMD, and the ability to protect communications by means of cryptographic methods, collectively or individually, can provide for an enhanced overall security in specific embodiments according to the present invention.

Embodiments provide a number of advantages, whether implemented individually or in various combinations. For example, the present invention makes it possible for the consumer to purchase a complete multi purpose label printer from a retail outlet and configure it to print postage. The weighscale and printer unit are not affected by postal regulations, and can be purchased outright and used immediately, just as any other computer peripheral. The printer can be used for general-purpose label-printing, or to print shipping tags for common carrier parcels, for example.

Once an SMD is installed, the printer can also print postage. Moreover, in a specific embodiment, prior to installing the SMD, the label printer can be used with an online service to download postage indicia messages and print postage indicia. Embodiments according to the invention can provide greater speed and increased flexibility of operation relative to conventional postage metering devices. Embodiments in which the print engine, processor, display, and weighscale are integrated can provide a number of advantages relative to conventional approaches. For example, control logic, or software control programs, can be significantly simplified, since many data transfers between devices are eliminated. The user interface can be simplified, since all control functions refer to the same computer.

The preceding has been a description of specific embodiments of the invention. It will be appreciated that deviations and modifications can be made without departing from the scope of the invention, which is defined by the appended claims.

What is claimed is:

1. A user-sealed configurable postage printing apparatus comprising:
a printing device, operable to print a postage indicium;
a processor, connected to said printing device;
an enclosure, containing said printing device and said processor, said enclosure having a cavity for receiving a secure metering device (SMD); and
a cover, mated with said enclosure to secure said SMD after insertion of said SMD into said cavity;
wherein insertion of said SMD into said cavity causes said processor and said printing device to be capable of printing postage drawing upon a postage credit stored within said SMD, and wherein, once inserted, attempted removal of said SMD causes visible damage to at least one of said SMD, said cover, and said enclosure.

2. The apparatus of claim 1, further comprising a latch, and wherein said cover is held closed by said latch.

3. The apparatus of claim 1, further comprising a latch, and wherein said SMD is held in place by said latch.

4. The apparatus of claim 1, wherein said SMD is a smartcard.

5. The apparatus of claim 1, wherein said SMD holds at least one cryptographic key.

6. The apparatus of claim 1, further comprising:
an interface to external devices, connected to said processor, to provide a communication path between said apparatus and a remote postal facility.

7. The apparatus of claim 6, wherein said processor interacts with said remote postal facility to perform at least one of registering said apparatus with postal authorities, checking said apparatus into or out of service, performing periodic inspections, purchasing additional postal credit, receiving purchased postal credit into said SMD and notifying a service center that security action has occurred for said SMD.

8. The apparatus of claim 6, wherein said processor interacts with a service center to purchase postal credit, and thereupon stores said postal credit in said SMD.

9. The apparatus of claim 6, wherein said processor detects an attempt to access said SMD, and thereupon reports said attempt to a service center.

10. The apparatus of claim 1, wherein said processor, upon detecting an attempt to access said SMD, deactivates said SMD.

11. A user-sealed configurable postage printing apparatus comprising:
a printing device, operable to print a postage indicium;
a processor, connected to said printing device;
an enclosure, containing said printing device and said processor, said enclosure having a cavity for receiving a secure metering device (SMD); and
an electrical connector, located within said cavity of said enclosure, for establishing a connection between said processor and said SMD;
wherein insertion of said SMD into said cavity causes said processor and said printing device to be capable of printing postage drawing upon a postage credit stored within said SMD, and wherein, once said SMD is inserted, attempted removal of said SMD inhibits said SMD from being used to print postage.

12. The apparatus of claim 11, further comprising a sensor, disposed to detect attempted tampering with said SMD, and whereupon said processor initiates a security measure responsive thereto.

13. The apparatus of claim 12, wherein said security measure comprises at least one selected from activating an audible alarm, activating a visible alarm, signaling a user's computer, signaling a remote computer, signaling a remote monitoring facility, and disabling functionality of said SMD.

14. The apparatus of claim 13, wherein said disabling security measure comprises at least one selected from clearing at least one cryptographic key, and clearing at least one postage register.

15. The apparatus of claim 12, wherein said processor and said sensor detect installation of a new SMD and reset said security measure responsive thereto.

16. The apparatus of claim 12, wherein said sensor detects at least one of opening of a cover, and removal of said SMD.

17. The apparatus of claim 12, wherein said sensor is at least one selected from a proximity sensor, an optical sensor, a mercury switch, a contact switch, and a relay.

18. The apparatus of claim 11, wherein said SMD contains postal credit pre-loaded thereon.

19. The apparatus of claim 18, wherein said SMD is disposable/recyclable, when said postal credit pre-loaded thereon has been depleted.

20. The apparatus of claim 18, wherein said SMD is disposable/recyclable, wherein said processor interacts with a service center to purchase postal credit, and thereupon stores said postal credit in said SMD.

21. An integrated user sealed postage printing apparatus, comprising:
a loadcell, coupled to a printer and a microcomputer, wherein each is contained within an enclosure, said enclosure having a cavity to receive a secure metering device (SMD), and a mechanism to secure said SMD from tampering, and wherein attempted removal of said SMD inhibits said SMD from being used to print postage.

22. A method for printing postage, said method comprising:
installing a secure metering device (SMD) into a posting workstation, said SMD comprising a secure storage area for postal credit;
securing said SMD;
checking said postage workstation in with a service center over a network connection; and
printing postage for at least one of a plurality of mail pieces drawing upon said postal credit from said SMD;
wherein once inserted, attempted removal of said SMD inhibits said SMD from being used to print postage.

23. The method of claim 22, further comprising:
purchasing postal credit over a network connection; and
storing postal credit purchased into said SMD.

24. The method of claim 22, further comprising:
obtaining postal credit stored within said SMD prior to installing said SMD in said postage workstation.

25. The method of claim 22, further comprising:
detecting an attempt to access said SMD after installation; and thereupon, deactivating said SMD.

26. The method of claim 25, further comprising:
responsive to said detecting said attempt to access said SMD, performing at least one selected from activating an audible alarm, activating a visible alarm, signaling a user's computer, signaling a remote computer, signaling a remote monitoring facility and disabling functionality of said SMD.

27. The method of claim 26, wherein said disabling functionality of said SMD further comprises at least one selected from clearing at least one cryptographic key, and clearing at least one postage register.

28. The method of claim 22, wherein said securing further comprises:
at least one selected from physically latching a cover enclosing said SMD, activating a sensor, activating a one-time latching mechanism.

29. The method of claim 22, further comprising:
obtaining administrative services from a service center over a communication connection.

30. The method of claim 29, wherein said administrative services further comprises at least one selected from: performing periodic inspections, transmittal of tamper-alarms to authorities, checking the meter out of service.
